(19) United States
(12) Patent Application Publication
(10) Pub. No.: US 2004/0153553 A1
(43) Pub. Date: Aug. 5, 2004

(54) System and method for use of mobile wireless devices for authentication of personal identification and registration with security network

(76) Inventors: Gregory Chotkowski, New York, NY (US); J. Jeffrey Freda, Montclair, NJ (US)

Correspondence Address: Dara L. Onofrio, Esq., c/o ONOFRIO LAW, 1133 Broadway - Suite 1600, New York, NY, 10010, US

(21) Appl. No.: 10/414,657

(22) Filed: Apr. 16, 2003

Related U.S. Application Data
(60) Provisional application No. 60/373,252, filed on Apr. 17, 2002.

(51) Int. Cl. G06F 15/16

(52) U.S. Cl. 709/229; 709/249

(57) ABSTRACT

A system for authentication of personal identification comprising, transmitting a signal from a wireless device containing identifying information of the user, and capturing the information on a central server system. The central server system identifies the information from the wireless device and requires a pin code from the user to confirm identity and requires an access point code from the user to indicate location. The pin code and access point codes are entered into the central server system to generate a unique event identifier. The unique event identifier is disseminated to a receiving station at the access point to authenticate the identify of user and to permits user access to the location.

### This application claims the benefit of U.S. provisional application No. 60/373,252 filed Apr. 17, 2001, which is incorporated herein by reference.

### FIELD OF THE INVENTION

The present invention relates to a system for utilizing mobile wireless devices such as cell phones, handheld computers, pagers, etc. to authenticate the identity of a person entering a building and granting that person access to a restricted area.

### BACKGROUND OF THE INVENTION

Building management companies have long provided security services for their tenants through stationing of a security guard at the entrance of the building. Visitors are required to check in with the guard in order to proceed to the tenant's office or residence. Often the visitor is announced by a phone call from the guard to the tenant who requests that the visitor be allowed entrance. In large buildings with a high volume of visitors, this call system often proves too inefficient to handle the high volume. In such instances, security guards are often instructed to check identification such as a driver's license or to require the visitor to sign a guest log before proceeding. Critics of such practices argue that these methods are inaccurate, illegible, prone to fraud, and difficult to review for tracking individuals who perpetrate building violations.

Recent terrorist actions in the US have highlighted breaches in current security systems and have prompted changes for improved authentication procedures.

The invention overcomes these problems by providing a method and system for linking a visitor with a unique identifier code which associates that visitor with his own personal identification number, a time and date stamp, and a precise description (building location, floor or suite number, person being visited, etc.) of his visit. The system does this by requiring the visitor to contact the central server through a wireless device, identifying the unique identifier code of the device (e.g. cell phone number through caller ID systems), verifying ownership of that device through visitor input of a personal identification number (PIN), documenting the time and date, requiring the visitor to input the building identifier code, and then generating an authorization message with a Unique Event Identifier (UEI) for the security guard to let the visitor proceed. The authorization message and UEI are created at the central server and then sent to the security guard via phone or the Internet for viewing on a variety of devices including a desktop or handheld computer, cell phone, pager or other. The authorization message is also sent to the tenant to inform them that a visitor has arrived.

The invention also provides a detailed log of all visits by time and day for each security access point. This log can be accessed for metrics, compliance and quality issues, investigations of security violations or other purposes deemed necessary for effective surveillance of the restricted area.

The invention also provides a method and means for linking information captured on the central server to other locations employing such a security system. Information could be shared to warn about possible security threats from specific individuals.

The invention further provides a means to communicate with visitors in emergency situations. Having a record of cell phone numbers within any given building at any given time, the central server could enable security providers to call visitors to disseminate information such as evacuation warnings in the event of a fire or building collapse.

Storing, receiving and accessing information according to the invention is easier than conventional paper logs.

### SUMMARY OF THE INVENTION

The invention provides a convenient and accurate method for identifying visitors to security personal at a restricted site through the use of mobile wireless devices and the Internet. Each digital broadcast device or automated voice system is comprised of a medium, a means for storing information on said medium and a means for transmitting the information on said medium to a mobile wireless device.

In general the automated identifier system is actuated by a visitor by dialing a designated phone number or contacting a designated website and then following the prompts to get to the desired clearance or authorization from the security guard for access to the restricted area. Each participating access point (building lobby, office suite, etc.) would have its own unique identifier.

Other objects, features and advantages of the present invention will be apparent when the detailed description of the preferred embodiments of the invention are considered with reference to the drawings, which should be construed in an illustrative and not limiting sense as follows:

### BRIEF DESCRIPTION OF THE DRAWINGS

FIG. 1 is a flow-chart diagram of the visitor process steps according to the invention; the central server process steps according to the invention and the security provider's process steps according to the invention.

### DETAILED DESCRIPTION OF THE INVENTION

In accordance with the present invention, in general a method and system for collection and dissemination of information is provided. More specifically, the method for collecting and disseminating information is from a wireless device containing identifying information. This information is transmitted from the wireless device to a central server and is captured a processed. After identification and access codes are obtained and authenticated by the central server system a unique identifying code specific to each event logged by the system is generated. The unique identifying code for each event is disseminated through phone, radio or Internet channels to authorized subscribers to the system.

In an embodiment of the invention, the transactional data obtained is stored within the central server system for further access or management of the information in a security network. In preferred embodiments, security networks are maintained for each individual location or building.

The system according to the invention further includes permitting subscribers to the system to connect to the world wide web for utilization of the information from the central server.

In a preferred embodiment of the invention a system for authentication of personal identification is provided by transmitting a signal from a wireless device containing identifying information of the user and capturing the information on a central server system. The central server system identifies the information from the wireless device and requires a pin code from the user to confirm identity and requires an access point code from the user to indicate location of the user. The pin code and access point code are entered into the central server system and if authenticated generate a unique event identifier. This unique event identifier is disseminated to a receiving station at the access point to authenticate the identity of user.

The receiving station according to the invention is a phone, computer or other mobile wireless device. The system permits a security guard to view the unique event identifier at said receiving station to grant access to user.

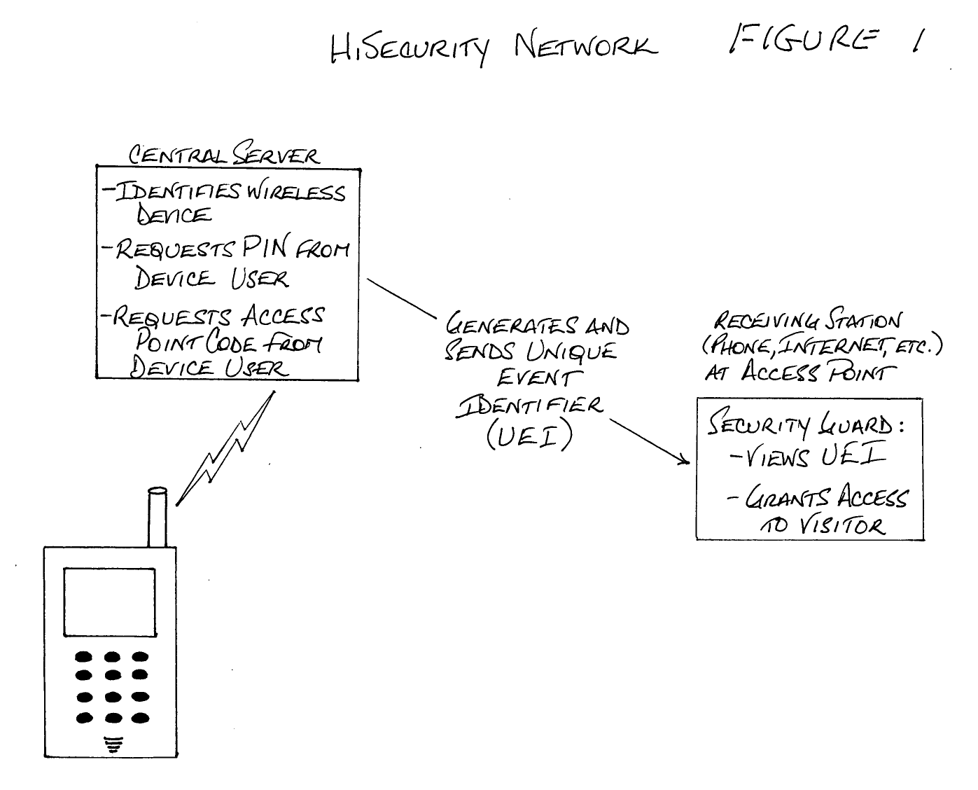

FIG. 1 illustrates the system according to the invention and the process steps involved for authentication of personal identification. The user or visitor transmits a signal from a wireless device containing identifying information of the user's device 1. This identifying information typically is the cell phone number and is captured on a central server system 2.

The central server system identifies the information from the wireless device and requests a pin code from the user to confirm identity and requests an access point code from the user to indicate location. The pin code is to confirm ownership of the wireless device. The central server also documents the time and date of the request and further requires the user or visitor to input the location or building identifier code.

After the pin code and access point codes are entered into the central service system a unique event identifier is generated 3.

The unique event identifier is disseminated to a receiving station 4 at the access point authenticating identify of user. The security guard views this identifier and permits the visitor to proceed. The authorization message and UEI are created at the central server and then sent to the security guard via phone or the Internet for viewing on a variety of devices including a desktop or handheld computer, cell phone, pager or other. The authorization message may also be sent to the individual or tenant receiving the visitor to inform them that a visitor has arrived.

The invention includes registration of the information with a security network which may be maintained for each individual location or building. The method and system of the invention include the provision of a detailed log of all visits by time and day for each security access point. This log can be accessed for metrics, compliance and quality issues, investigations of security violations or other purposes deemed necessary for effective surveillance of the restricted area. The log and report can be customized according to the end-users needs.

The invention method includes means for linking information captured on the central server to other locations employing such a security system. This information could be shared to warn about possible security threats from specific individuals.

The invention also provides a means to communicate with visitors in emergency situations. Having a record of cell phone numbers within any given building at any given time, the central server could enable security providers to call visitors to disseminate information such as evacuation warnings in the event of a fire or building collapse.

Storing, receiving and accessing information according to the invention is easier than conventional paper logs and could be saved in back-up systems to insure data is not destroyed or lost.

The invention now being fully described, it will be apparent to one of ordinary skill in the art that many changes and modifications can be made thereto without departing from the spirit or scope of the invention as set forth herein.

What is claimed is:

1. A system for collection and dissemination of information comprising:
various media;
a means for storing information on each medium; and
a means for transmitting the information on said medium to various access points including a desktop personal computer, a handheld computer, a cellular phone or other mobile wireless devices.

2. A method for collecting and disseminating information from a wireless device comprising the steps of:
providing a wireless device containing information;
transmitting the information from said wireless device;
capturing of the information by a central server;
combining the information with a unique identifying code specific to each event logged by the system;
disseminating a unique message for each event through phone, radio or Internet channels to authorized subscribers to the system

3. The method as defined in claim 2, comprising the further step of storing, accessing and/or managing the information.

4. The method as defined in claim 2, comprising the further step of connecting to the world wide web for utilization of the information.

5. A system for authentication of personal identification comprising:
transmitting a signal from a wireless device containing identifying information of the user;
capturing the information on a central server system; wherein said central server system identifies said information from the wireless device and requires a pin code from the user to confirm identity and requires an access point code from the user to indicate location;
entering said pin code and access point code into said central server system to generate a unique event identifier;
disseminating said unique event identifier to a receiving station at the access point authenticating identify of user.

6. The system according to claim 5, wherein said receiving station is a phone, computer or other mobile wireless device.

7. The system according to claim 6, wherein a security guard views said unique event identifier at said receiving station and grants access to user.
